(19) United States
(12) Patent Application Publication
(10) Pub. No.: US 2004/0070112 A1
(43) Pub. Date: Apr. 15, 2004

(54) Film applique for composite molded parts

(76) Inventors: Del C. Schroeder, Bloomfield Hills, MI (US); Richard D. Pistole, West Bloomfield, MI (US); Jeremy A. Panasiewicz, Pontiac, MI (US); David G. Speth, Sylvan Lake, MI (US); Kenneth C. Oikarinen, Novi, MI (US)

Correspondence Address: DAIMLERCHRYSLER INTELLECTUAL CAPITAL CORPORATION, CIMS 483-02-19, 800 CHRYSLER DR EAST, AUBURN HILLS, MI, 48326-2757, US

(21) Appl. No.: 10/270,906

(22) Filed: Oct. 15, 2002

(51) Int. Cl. B28B 7/22

(52) U.S. Cl. 264/255; 264/266

(57) ABSTRACT

A method and arrangement of bonding a film applique to a molded item produces a bright, textured and/or colored surface on a resin transfer molded item. The film is vacuum formed and placed into a female cavity of a mold. The film bonds to the molded item during the resin injection and solidification steps.

### FIELD OF THE INVENTION

The present invention relates to a method of forming a bright or colored surface on a resin transfer molded item by placing a surface film in the molding tool prior to the molding process.

### BACKGROUND OF THE INVENTION

Composite wheels for automotive applications are typically fiberglass composite. Polymer molding can be used to produce a composite wheel but the exterior surface of the unfinished wheel may not be aesthetically pleasing to the general automotive consumer. Wheel covers can be used to improve the appearance of composite wheels but require additional expense and man power. Composite wheels can be prepared and painted after manufacture but this process involves additional expense, man power and waste. What is needed is a process whereby a composite wheel can be produced with a finished exterior surface that is less expensive and reduces labor cost.

### SUMMARY OF THE INVENTION

In one aspect of the present invention, a surface film is vacuum formed and placed in a heated tool for molding a composite wheel. The tool may be adapted to mold the entire wheel or an outer portion. A pre-form is then placed into the tool. The pre-form is formed from fiberglass, carbon fiber or the like. The mold is closed and a resin is injected into the mold. The resin wets the pre-form and displaces the air inside the mold. The heat from the mold causes the resin to cure into a thermoset or thermoplastic composite. The molding process bonds the surface film to the resin substrate. A tie layer may be applied to the surface film prior to molding to enhance the bond with the substrate. The tie layer, if utilized, reacts with both the resin and the surface layer during molding. The finished outer surface of the film will be a bright (chrome) or paint or textured surface depending upon the surface film selected.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a composite wheel in accordance with the present invention.

FIG. 2 is an exploded view of the composite wheel of FIG. 1, showing the surface film of the present invention.

### DETAILED DESCRIPTION OF THE PREFERRED EMBODIMENTS

The following description of the preferred embodiments is merely exemplary in nature and is in no way intended to limit the invention, its application, or uses.

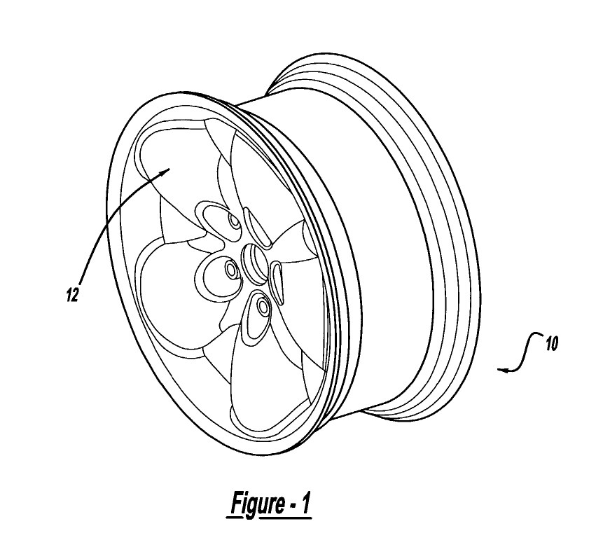

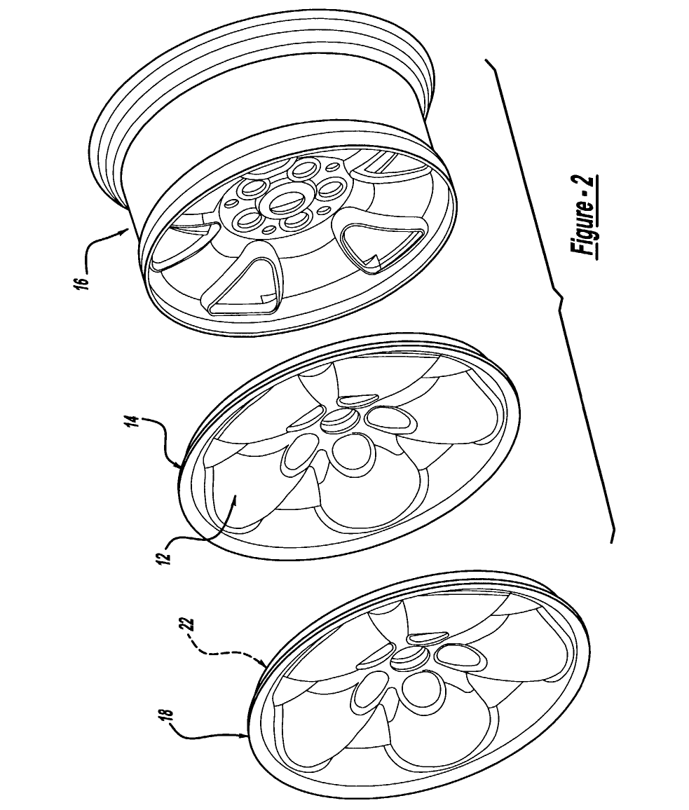

FIG. 1 shows a composite wheel 10. Composite wheel 10 has an exterior surface 12. When composite wheel 10 is produced by resin transfer molding, exterior surface 12 resembles a typical composite woven fiber surface. FIG. 2 shows a two piece composite wheel 10 including an outer portion 14 and an inner portion 16. Outer portion 14 and inner portion 16 are molded separately, preferably using resin transfer molding.

A surface film 18 is preferably prepared using vacuum forming to mimic the contour of exterior surface 12 which is also the contour of an interior surface of a molding tool. The contour may be a smooth surface or a textured surface, such as a raised design, logo or pattern. Surface film 18 is placed in the molding tool (not shown). A pre-form (not shown) is placed into the tool. The pre-form is preferably constructed of woven carbon fiber, polyimide, aramid fibers, boron, metals, spider silk, polyesters, liquid crystalline polymer or fiberglass and is shaped substantially identical to outer portion 14. The tool is closed and a resin is injected into the tool. After the resin cures, the tool is opened and outer portion 14 is removed. By this process, the resin will have displaced the air between the woven fibers and adjacent to surface film 18. Surface film 18 is bonded to exterior surface 12 of outer portion 14. While the resin is preferably polyester, vinyl ester or epoxy, it will be recognized by one skilled in the art that other polymers suitable for molding may be used, such as cyanate ester, polyimide, polyimideamide, bismaleimides, polyaryletherketone, and polyetheretherketone. Surface film 18 is bonded to exterior surface 12 in such a manner as to provide a durable, aesthetically pleasing surface for composite wheel 10. A tie layer 22 may be formed with surface film 18. Tie layer 22 preferably includes acrolonitrile-butadiene-styrene (ABS) or acrolonitrile-styrene-acrylate (ASA) but may also include polyethylene terephthalate (PET), polybutylene terephthalate (PBT), polycarbonate (PC), polypropylene (PP), and thermoplastic polyolefin (TPO).

Surface film 18 may be an extruded color film or a paint film such as polyvinylidene fluoride (PVDF) or polyvinyl fluoride (PVF) with the optional tie layer 22 adjacent thereto. Tie layer 22, if present, improves the bond between surface film 18 and outer portion 14. Surface film 18 may also be ionomer, acrolonitrile-butadiene-styrene (ABS) with chrome or SOLLX™. Other components, such as deck lids, roofs, hoods, doors, wheel covers, bump strips and grilles may also be formed using the method described herein.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of forming a finished surface on a molded item comprising:
forming a surface film, said surface film adapted to be received within a tool;
positioning said surface film within said tool;
inserting a pre-form into said tool; and
injecting a resin into said tool.

2. The method of claim 1, wherein the step of forming said surface film further comprises vacuum forming.

3. The method of claim 1, wherein said resin is selected from a group consisting of polyester, vinyl ester, epoxy, cyanate ester, polyimide, polyimideamide, bismaleimides, polyaryletherketone, polyetheretherketone and combinations thereof.

4. The method of claim 1, wherein said surface film is selected from a group consisting of ionomer, ABS, PVDF and PVF.

5. The method of claim 1, wherein said surface film comprises a paint film.

6. The method of claim 1, wherein the step of forming said surface film further comprises forming said surface film with a textured surface.

7. The method of claim 1, wherein said pre-form comprises woven fibers.

8. The method of claim 1, wherein said pre-form comprises fibers selected from the group consisting of fiberglass, carbon fiber, polyimide, aramid fibers, boron, metals, spider silk, polyesters, liquid crystalline polymer and combinations thereof.

9. The method of claim 1, further comprising the step of placing a tie layer within the tool adjacent said surface film.

10. The method of claim 9, wherein said tie layer is selected from the group consisting of ABS, ASA, PC, PET, PBT, PP, TPO and combinations thereof.

11. The method of claim 1, wherein said molded item is a thermoplastic composite.

12. The method of claim 1, wherein said molded item is a thermoset composite.

13. A molded item comprising:
a substrate, said substrate molded within a tool, said substrate comprising:
a pre-form adapted to be placed within said tool;
a resin cured to form a desired shape; and
a surface film, said surface film adapted to be attached to said substrate during a molding process.

14. The molded item of claim 13, wherein said surface film is vacuum formed.

15. The molded item of claim 13, wherein said molded item is a thermoplastic composite.

16. The molded item of claim 13, wherein said molded item is a thermoset composite.
